(19) United States
(12) Patent Application Publication
(10) Pub. No.: US 2005/0025197 A1
(43) Pub. Date: Feb. 3, 2005

(54) Repairing structure of driving circuit

(75) Inventor: Jian-Shen Yu, Hsinchu City (TW)

Correspondence Address: BACON & THOMAS, PLLC, 625 SLATERS LANE, FOURTH FLOOR, ALEXANDRIA, VA, 22314, US

(73) Assignee: AU Optronics Corp., Hsinchu City (TW)

(21) Appl. No.: 10/698,454

(22) Filed: Nov. 3, 2003

(30) Foreign Application Priority Data
Mar. 14, 2003 (TW) 92105603

(51) Int. Cl. H04J 3/04

(52) U.S. Cl. 370/535

(57) ABSTRACT

A repairing structure of an integrated driving circuit for flat panel displays is disclosed. The repairing structure of the integrated driving circuit includes at least one driving circuit, a multiplexer unit and a display area. The multiplexer unit is connected to the at least one driving circuit through a plurality of video signal lines, and also, is connected to the display area through a plurality of data lines. The multiplexer unit further includes a dummy portion having a plurality of input-leads and a plurality of output-leads for repairing the connection between the multiplexer unit and the driving circuit or the display area.

### BACKGROUND OF THE INVENTION

1. Field of the Invention

The present invention relates to a driving circuit, and more particularly to a repairing structure of an integrated driving circuit for flat panel displays.

2. Description of Related Art

FIG. 1 shows a conventional driving circuit for flat panel displays. The driving circuit 11 supplies analog video signals. The analog video signals are output to a multiplexing circuit 12, consisting of switch elements, through a plurality of video signal lines 15. The multiplexing circuit 12 receiving the analog video signals is connected to a plurality of control lines 14. The control lines 14 transfer control signals for controlling switch elements in the multiplexing circuit 12 to selectively output video signals. The multiplexing circuit 12 supplies the video signals to a display area 13 through a plurality of data lines 16 so as to drive the display area 13.

However, the plurality of video signal lines 15 connected between the driving circuit 11 and the multiplexing circuit 12 or the plurality of data lines 16 connected between the multiplexing circuit 12 and the display area 13 or some switch elements of the multiplexing circuit 12 may have an open circuit (line disconnection or poor electrical contact) problem after fabrication process. As a result, the manufacturing yield rate of the products and the picture quality of the display area 13 are both below expectations.

Therefore, it is desirable to provide a repairing structure of an integrated driving circuit for flat panel displays to mitigate and/or obviate the aforementioned problems.

### SUMMARY OF THE INVENTION

It is the primary object of the present invention to provide a repairing structure of an integrated driving circuit for flat panel displays so as to ameliorate the manufacturing yield rate and ensure function of the integrated driving circuit for the display area.

It is another object of the present invention to provide a repairing structure of an integrated driving circuit for flat panel displays so as to improve the picture quality.

To accomplish the above-mentioned objects, a repairing structure of an integrated driving circuit for flat panel displays according to the present invention, in cooperation with at least one driver chip, comprises: a plurality of video signal lines connected to the driver chip for supplying video signals, a multiplexer unit connected to the plurality of video signal lines; a plurality of data lines connected to the multiplexer unit, and a display area connected to the plurality of data lines so that at least one driving circuit outputs the video signals to the multiplexer unit through the video signal lines and then the video signals are output to the display area through the multiplexer unit and the plurality of data signal lines. The multiplexer unit further comprises at least one dummy portion having a plurality of spare input-leads and a plurality of spare output-leads for repairing the connection between the multiplexer unit and the at least one driving circuit or the connection between the multiplexer unit and the display area.

The said spare input-leads and the said spare output-leads cross the video signal lines and the data lines respectively. Before repair, neither the said spare input-leads are connected to the video signal lines nor are the said spare output-leads connected to the data lines. When the multiplexer unit fails to connect at least one video signal line connected to the at least one driving circuit, at least one spare input-lead is connected to the at least one video signal line. When the multiplexer unit fails to connect at least one data line connected to the display area, at least one output-lead is connected to the at least one data line. The at least one spare input-lead is connected to the at least one video signal line by laser repairing technology; or alternatively, the at least one output-lead is connected to the at least one data line by laser repairing technology. With at least one spare unit, the number of input connecting lines of the multiplexer unit is more than the number of the video signal lines.

Other objects, advantages, and novel features of the invention will become more apparent from the following detailed description when taken in conjunction with the accompanying drawing.

### BRIEF DESCRIPTION OF THE DRAWINGS

FIG. 1 is a schematic view of a conventional driving circuit for flat panel displays; and

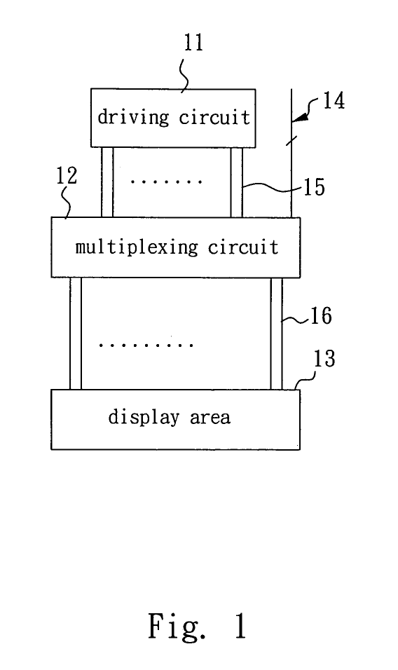

FIG. 2 is a schematic view of a repairing structure of a driving circuit according to a preferred embodiment of the present invention.

### DETAILED DESCRIPTION OF THE PREFERRED EMBODIMENT

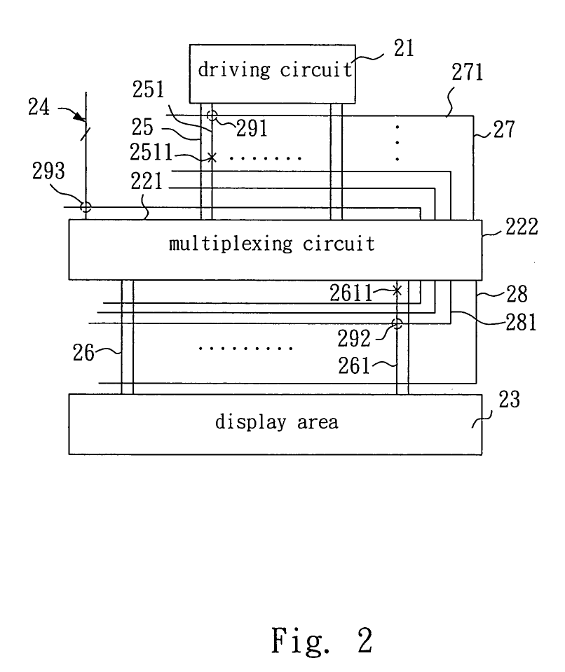

FIG. 2 is a preferred embodiment of the present invention, illustration a repairing structure of a driving circuit. As shown, a driving circuit 21, a multiplexing circuit 221 and a display area 23 are provided. The driving circuit 21 outputs analog video signals, and is connected to the multiplexing circuit 221 through a plurality of video signal lines 25 to output the analog video signals to the multiplexing circuit 221.

The multiplexing circuit 221 is connected to at least one control signal line 24 to receive control signals transferred from the control signal lines 24. The control signals control the switch elements 220 of the multiplexing circuit 221 so as to selectively output the analog video signals to the data lines 26. The multiplexing circuit 221 is connected to the display area 23 through a plurality of data lines 26 to output the analog video signals to the display area 23.

The multiplexing circuit 221 comprises at least one dummy portion 222. The position of the dummy portion 222 in the multiplexing circuit 221 is not specifically defined, and can be mounted on one side of the multiplexing circuit 221 or within the multiplexing circuit 221. In the present embodiment, it is preferable to have only one dummy portion 222 mounted at the right-hand side of the multiplexing circuit 221. The dummy portion 222 has a spare input-lead 27 and a plurality of spare output-leads 281 and 282. The spare input-lead 27 is used for repairing the connection between the multiplexing circuit 221 and the driving circuit 21. The spare output-leads 281 and 282 are used for repairing the connection between the multiplexing circuit 221 and the display area 23.

The number of the input connecting lines of the multiplexing circuit 221 including the dummy portion 222 (i.e., the sum of the spare input-lead 27 and the video signal lines 25) is more than that of video signal lines 25 output from the driving circuit 21 in order for the spare input-lead 27 to repair the connection between the multiplexing circuit 221 and the driving circuit 21, if any open circuit occurs.

Before repair, neither the spare input-lead 27 is connected to the video signal lines 25 nor are the spare output-leads 28 connected to the data lines 26. When a switch element 223 shows an open-circuit behavior, the spare input-lead 27 is connected to the video signal line 251 at intersection 291 by repairing technology. In the present embodiment, the repairing technology is preferably a laser repairing technology. Similarly, the spare output-lead 281 connected to a data line 261 is selected from the spare output-leads. Furthermore, the spare output-lead 281 is connected to the data line 261 at intersection 292 by the laser repairing technology.

In sum, the present invention adds a dummy portion to the multiplexing circuit. The spare input-leads or the spare output-leads of the dummy portion are used for repairing the connection between the multiplexing circuit and the driving circuit or the display area. Hence, the manufacturing yield rate is ameliorated, the driving circuit is capable of driving the display area in any circumstances, and deterioration of the picture quality of the display area is prevented.

Although the present invention has been explained in relation to its preferred embodiment, it is to be understood that many other possible modifications and variations can be made without departing from the spirit and scope of the invention as hereinafter claimed.

1. A repairing structure of an integrated driving circuit for flat panel displays, in cooperation with at least one driver chip, comprising:
a plurality of video signal lines connected to the driver chip for supplying video signals;
a multiplexer unit connected to said plurality of video signal lines;
a plurality of data lines connected to said multiplexer unit; and
a display area connected to said plurality of data lines so that at least one driving circuit outputs said video signals to said multiplexer unit through said video signal lines and then data signals are output to said display area through said multiplexer unit and said plurality of data signal lines;
wherein said multiplexer unit further comprises at least one dummy portion having a plurality of spare input-leads and a plurality of spare output-leads for repairing the connection between said multiplexer unit and said at least one driving circuit or the connection between said multiplexer unit and said display area.

2. The repairing structure of the integrated driving circuit of claim 1, wherein said spare input-leads and said spare output-leads cross said video signal lines and said data lines respectively without any connection therebetween.

3. The repairing structure of the integrated driving circuit of claim 1, wherein said spare input-leads are used when said multiplexer unit fails to connect at least one said video signal line connected to said at least one driving circuit, so that at least one said spare input-lead is connected to said at least one video signal line.

4. The repairing structure of the integrated driving circuit of claim 3, wherein said at least one spare input-lead is connected to said at least one video signal line by laser repairing technology.

5. The repairing structure of the integrated driving circuit of claim 1, wherein at least one said output-lead is connected to at least one said data line when said multiplexer unit fails to connect said at least one data line connected to said display area.

6. The repairing structure of the integrated driving circuit of claim 5, wherein said at least one output-lead is connected to said at least one data line by laser repairing technology.

7. The repairing structure of the integrated driving circuit of claim 1, wherein said multiplexer unit is further connected to at least one control signal line to receive control signals output from said at least one control signal line, and at least one said spare input-lead is capable of repairing the connection between said at least one control signal line and said multiplexer unit.

8. The repairing structure of the integrated driving circuit of claim 1, wherein said multiplexer unit has input connecting lines including said spare input-leads, said video signal lines and said at least one control signal line, and the number of said input connecting lines is more than that of said video signal lines.
